(19) United States
(12) Patent Application Publication
(10) Pub. No.: US 2012/0107191 A1
(43) Pub. Date: May 3, 2012

(54) Food quality indicator

(76) Inventors: James R. Strahle, Braintree, MA (US); Claudia Donnet, Arlington, MA (US)

(21) Appl. No.: 13/317,228

(22) Filed: Oct. 12, 2011

Related U.S. Application Data
(60) Provisional application No. 61/404,908, filed on Oct. 12, 2010.

(51) Int. Cl. G01N 21/78

(52) U.S. Cl. 422/401

(57) ABSTRACT

A food quality indicator includes a bio-indicator insert interposed between a gas-permeable, waterproof base and an impervious transparent cover, the base and the cover being sealed together about their peripheries to completely enclose the bio-indicator insert therebetween. The bio-indicator insert includes a porous substrate onto which a biosensor solution is applied, the biosensor solution being at least partially externally visible through the transparent cover. In use, the biosensor solution is adapted to change color within a defined color range that is dependent upon the concentration of amines detected. In this manner, the food quality indicator provides a visual indication of the state of microbial spoilage experienced by a food product in close proximity thereto. Due to its unitary, compact, durable and waterproof design, the food quality indicator can be used in a variety of potential applications and integrated into an array of different products, such as food storage containers.

### CROSS-REFERENCE TO RELATED APPLICATIONS

The present application claims the benefit of U.S. Provisional Patent Application Ser. No. 61/404,908, which was filed on Oct. 12, 2010 in the name of James R. Strahle, the disclosure of which is incorporated herein by reference.

### FIELD OF THE INVENTION

The present invention relates generally to food safety and more particularly to food quality indicators used to detect levels of microbial spoilage in perishable food products.

### BACKGROUND OF THE INVENTION

Food products with substantial amounts of proteins, such as red meat, pork, poultry, processed meat and seafood, spoil over time due to the growth of microbes, such as bacteria, yeasts and fungi. Bacterial decomposition of protein-based perishable foods in turn produces certain volatile chemical compounds known as amines. Putrescine, cadaverine and histamine are the primary, amines produced by proteins during decomposition, with the level of amines produced directly corresponding to the degree of microbial spoilage.

As can be appreciated, the consumption of perishable foods with significant levels of microbial spoilage can result in the contraction of various types of foodborne illnesses. Accordingly, as a protective measure, the United States Food and Drug Administration (FDA) promotes adherence to a food spoilage safety standard of approximately 10 million colony forming units per gram, or CFU/g. Food products with measured bacterial levels above the FDA standard are considered unsafe for consumption and should therefore be immediately discarded.

Laboratory testing is periodically performed to ensure that perishable food products delivered to consumers meets the food spoilage safety standard. Although effective, laboratory testing is relatively expensive, time-consuming and often limited in its availability. As a result, laboratory-quality testing is only performed, if at all, at specified points during the food product supply chain. Furthermore, it is to be understood that once the food product has been purchased, consumers do not similarly have access to laboratory-quality testing to continuously monitor the spoilage state of the product.

Rather, food spoilage is traditionally monitored at the consumer level by either discarding certain products after a predefined period of time (e.g., 3-5 days after opening the food packaging) and/or using basic observational testing (e.g., spot testing of the product by sight, smell or taste). However, since these traditional methods are largely subjective and speculative in nature, they have been found to be highly ineffective in preventing the consumption of food products with unsafe spoilage levels.

Accordingly, consumer-based food quality indicators are known in the art for measuring microbe levels in food products. One type of food quality indicator, or FQI, that is known in the art is constructed in the form of a label that is designed to be affixed to either the inside of a clear food packaging or the outside of a breathable or gas-permeable food packaging. The label includes an externally viewable indicator composition, or biosensor, that is sensitive to the presence of amines and, in response thereto, changes color based on amount of amines detected. In this manner, an individual can visually determine the extent of microbial spoilage for a particular food product by observing the color state of the biosensor.

For instance, in U.S. Patent Application Publication No. 2006/0057022, which published on Mar. 16, 2006 in the names of John R. Williams et al., there is disclosed a label-type food quality indicator that is designed to detect unhealthy levels of food spoilage in a sealed food product package, the disclosure of which is incorporated herein by reference. In one embodiment, the food quality indicator includes a porous substrate layer onto which is applied an indicator composition, the indicator composition being adapted to change color in response to the presence of chemical compounds that are characteristic of decomposing foods. A patterned adhesive is applied to the underside of the substrate layer to enable the indicator to be affixed to food packaging. In addition, a polyethylene film is secured to the top of the substrate layer by another adhesive layer, the polyethylene film including a die cut window for viewing the color state of the indicator composition.

As can be appreciated, label-type food quality indicators of the type described in the '022 application have been found to suffer from a number of notable shortcomings.

As a first shortcoming, label-type food quality indicators of the type described above include die cuts in one or more its layers in order to, inter alia, adequately expose the indicator composition to amines produced by the food product as well as provide an opening for visually inspecting the color state of the indicator composition. However, it should be noted that the inclusion of die cuts in selected layers prematurely exposes the indicator composition to certain environmental contaminants that can significantly jeopardize its accuracy, such as moisture. As a result, proactive steps are typically required to limit the likelihood of contamination of the biosensor throughout all stages of the manufacture, packaging and use of the food quality indicator, which is highly undesirable.

As a second shortcoming, label-type food quality indicators of the type as described in detail above are relatively complex in construction and, as such, are expensive to manufacture, which is highly undesirable. Specifically, as noted above, each indicator includes a large quantity of individual layers that are independently die cut. In addition, the plurality of layers is permanently affixed together in a stacked fashion by separately applying multiple layers of adhesives.

### BRIEF SUMMARY OF THE INVENTION

It is an object of the present invention to provide a new and improved food quality indicator for detecting levels of microbial spoilage in perishable food products.

It is another object of the present invention to provide a food quality indicator of the type as described above that includes a biosensor that is acutely sensitive to the presence of amines produced from microbial spoilage and, in response thereto, changes color based on the amount of amines detected.

It is yet another object of the present invention to provide a food quality indicator of the type as described above that effectively seals the biosensor from moisture.

It is still another object of the present invention to provide a food quality indicator of the type as described above that has a limited number of parts, is inexpensive to manufacture, is highly accurate in nature and is easy to use.

It is yet still another object of the present invention to provide a food quality indicator of the type as described above that is designed for integration into a wide variety of different products and for use in a broad range of potential applications.

Accordingly, as a primary feature of the present invention, there is provided a food quality indicator comprising (a) a gas-permeable and waterproof base, the base having a top surface and a bottom surface, (b) an impervious transparent cover, the cover having a top surface and a bottom surface, and (c) a bio-indicator insert interposed between the base and the cover, the bio-indicator insert being adapted to sense the presence of compounds characteristic of decomposing food, at least a portion of the bio-indicator insert being externally viewable through the transparent cover, (d) wherein the base and transparent cover are coupled together so as to completely enclose the bio-indicator insert therebetween.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a top view of a first embodiment of a food quality indicator constructed according to the teachings of the present invention;

FIG. 2 is a section view of the food quality indicator shown in FIG. 1, taken along lines 2-2;

FIG. 3 is a front view of a food container constructed according to the teachings of the present invention;

FIG. 4 is a side view of the food container shown in FIG. 3, the food container being shown prior to activation of the food quality indicator;

FIG. 5 is a side view of the food container shown in FIG. 3, the food container being shown after activation of the food quality indicator;

FIG. 6 is a transverse section view of a second embodiment of a food quality indicator constructed according to the teachings of the present invention; and

FIG. 7 is a simplified block diagram of a food supply chain management system that allows for the monitoring and control of food products using food quality indicators of the type shown in FIG. 6.

### DETAILED DESCRIPTION OF THE INVENTION

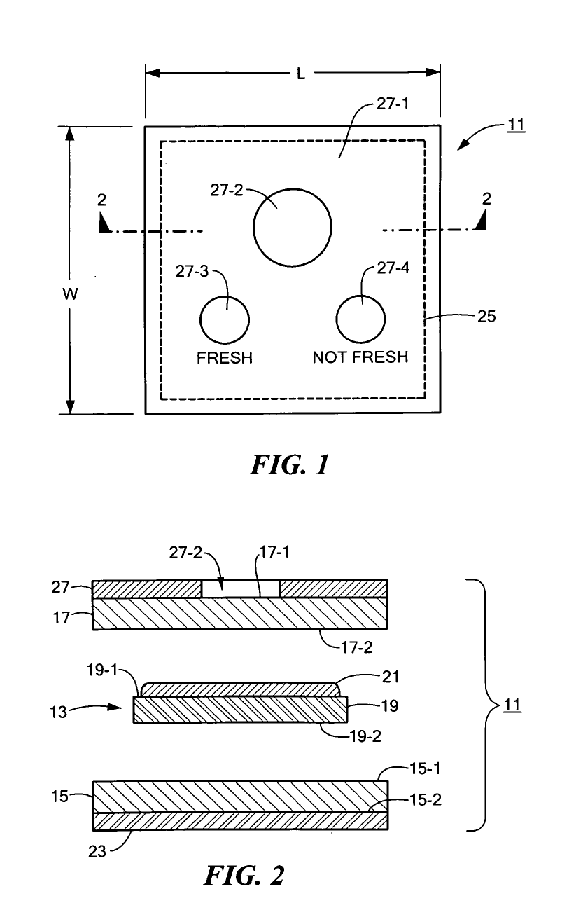

Referring now to FIGS. 1 and 2, there are shown top and exploded section views, respectively, of a first embodiment of a food quality indicator that is constructed according to the teachings of the present invention, the food quality indicator (FQI) being identified generally by reference numeral 11. As will be described in detail below, food quality indicator 11 is designed to provide a visual indication of the state of microbial spoilage experienced by a particular food product.

For purposes of simplicity only, food quality indicator 11 is described herein as being used to detect the decomposition, or spoilage, of food products with substantial amounts of proteins, such as red meat, pork, poultry, processed meat and seafood. However, it is to be understood that food quality indicator 11 could be recalibrated for use in detecting the presence of other forms of amine producing biological agents, such as bacteria, mold or fungus, without departing from the spirit of the present invention.

As seen most clearly in FIG. 2, food quality indicator, or FQI, 11 comprises a bio-indicator insert 13 that is interposed between a gas permeable base 15 and a transparent cover 17. As will be described further below, amines present in the immediate environment of FQI 11 penetrate through gas permeable base 15 and are ultimately sensed by bio-indicator insert 13. In response thereto, bio-indicator insert 13 changes color within a defined color range that is dependent upon the concentration of amines detected, the color status of insert 13 being externally viewable through transparent cover 17.

FQI 11 is preferably constructed as a unitary, fully enclosed, waterproof pouch, or packet, that has an overall length L of approximately 1.75 inches and an overall width W of approximately 1.75 inches, as shown in FIG. 1. In this capacity, the self-contained and durable design of FQI 11 renders it suitable for a wide range of potential applications, as will be discussed further in detail below.

As seen most clearly in FIG. 2, bio-indicator insert 13 comprises a porous substrate 19 onto which is applied a biosensor solution, or composition, 21 that changes color in response to the presence of amines (i.e., volatile chemical compounds that are characteristic of decomposing foods).

Porous substrate 19 is preferably constructed of any porous material onto or into which biosensor solution 21 may be applied. As defined herein, “porous” materials include those having a continuous, discontinuous, structured or random structure with channels of pores that allow for the absorption, adsorption or attachment of an indicator composition thereto, and which allow for fluid communication across uncoated portions thereof.

Porous substrate 19 is preferably as “inert” as possible (i.e., one which, in the absence of color-changing reactants, does not adversely impact the stability or color of biosensor composition 21 over time). As such, it is to be understood that porous substrate 19 is desirably pH balanced so as not to change the color of biosensor solution 21.

For example, porous substrate 19 may be in the form pH neutral, contaminant-free, chromatography quality cellulose paper of the type manufactured and sold by Whatman® Inc., of Piscataway, N.J. as catalog number 3001-861 cellulose chromatography paper. However, it is to be understood that porous substrate 19 could be constructed using alternative materials, such as plastic, cotton, flax, resin, glass, fiberglass or fabric, without departing from the spirit of the present invention.

Porous substrate 19 is cut, stamped or otherwise formed as a strip of material that includes a substantially flat top surface 19-1 and a substantially flat bottom surface 19-2. The dimensions of substrate 19 are preferably smaller in length and width than the overall footprint for FQI 11. For instance, substrate 19 is preferably approximately 25 mm in length and approximately 25 mm in width. In this manner, porous substrate 19 is appropriately dimensioned to be completely sealed between base 15 and cover 17, as will be described further below.

Biosensor, or indicator, solution 21 represents any organic composition that is designed to change noticeably in color in the presence of volatile compounds that are characteristic of decomposing food, such as amines. Preferably, the active ingredient in biosensor solution 21 is red cabbage extract of the type manufactured and sold by Colarome Inc., of Saint-Hubert, Canada as product code XCR-505L red cabbage juice concentrate.

However, it should be noted that composition 21 is not limited to the use of red cabbage extract as the active ingredient for composition 21. Rather, it is to be understood that other types of colormetric indicators, such as the indicators described in U.S. Patent Application No. 2006/0057022 to John R. Williams, which is incorporated herein by reference, could be used in place thereof without departing from the spirit of the present invention. For example, the active ingredient can be selected from the group consisting of cabbage extract, beet extract, anthocyanins, anthocyanidins, flavonoids, belatin, belatin derivates and combinations thereof.

A 25 microliter volume of biosensor solution 21 is preferably pressure dropped onto top surface 19-1 so as to form a circular spot, or indicator region, which is approximately 24 mm in diameter. In this manner, biosensor solution 21 is suitable in size to allow for the visual inspection of its color status.

Preferably, FQI 11 is calibrated for a specific food product by varying the concentration of biosensor solution 21 based upon certain amine-producing characteristics associated with the product (e.g., how quickly the product traditionally spoils). In the present invention, FQI 11 is also preferably calibrated to clearly indicate an unsafe level of product spoilage that is significantly lower than the FDA food spoilage standard (e.g., to indicate food spoilage upon reaching 8 million CFU/g).

As seen most clearly in FIG. 2, Base 15 is preferably constructed out of a layer of material that is both (i) gas-permeable, or breathable, (i.e., allows for selective or non-selective exchange of gases or vapors) and (ii) waterproof, or water-tight, (i.e., completely impervious to water or other similar liquids). For example, base 15 may be in the form of gas permeable, water-tight paper that is currently manufactured and sold by E.I. duPont de Nemours & Co., of Wilmington, Del. as model 1025BL Tyvek® material.

Base 15 is preferably formed as a thin, square-shaped strip of material that includes a substantially flat top surface 15-1 and a substantially flat bottom surface 15-2. As can be appreciated, base 15 provides the basic dimensional footprint for FQI 11. Accordingly, in the present embodiment, base 15 preferably has a length of approximately 1.75 inches and a width of approximately 1.75 inches.

A removable air-tight seal 23 is applied to bottom surface 15-2 of base 15 by any suitable means, such as an adhesive. It should be noted that seal 23 is preferably dimensioned to cover the entirety of bottom surface 15-2. Accordingly, in the present embodiment, seal 23 has a length of at least approximately 1.75 inches and a width of at least approximately 1.75 inches.

While affixed to bottom surface 15-2, seal 23 serves an impervious barrier that prevents the passage of gases or vapors through base 15. In this capacity, it is to be understood that FQI 11 is not activated for use in monitoring food spoilage until seal 23 is physically removed from base 15. As a result, FQI 11 can be stored, packaged and/or transported prior to its intended use without the risk of premature activation and/or contamination of biosensor solution 21, which is a principal object of the present invention.

Cover 17 is preferably constructed using a thin sheet of clear, print receptive plastic material that is impervious to common household or environmental contaminants, such as water, water vapor, hand oils, dust and gases. Cover 17 is preferably formed as a square-shaped strip that has the same basic dimensional footprint as base 15 (i.e., approximately 1.75 inches in length by approximately 1.75 inches in width), cover 17 comprising a substantially flat top surface 17-1 and a substantially flat bottom surface 17-2.

With food quality indicator 11 in its assembled state, bottom surface 19-2 of porous substrate 19 is disposed directly onto top surface 15-1 of base 15 in a generally centered relationship relative thereto. In addition, cover 17 is disposed over bio-indicator insert 13 in alignment with base 15. Furthermore, bottom surface 17-2 of cover 17 and top surface 15-1 base 15 are joined together about their peripheries by a weld line, or heat seal, 25, as shown in FIG. 1. As can be appreciated, weld line 25 serves to completely seal off bio-indicator insert 13 from moisture and other environmental conditions, which is highly desirable. As such, food quality indicator 11 is constructed as a unitary, self-contained and waterproof device that resembles an enclosed pouch or pocket.

It is to be understood that FQI 11 could be constructed in any suitable manner. For example, top surface 15-1 of base 15 and bottom surface 17-2 of cover 17 could be welded together along three side edges to form a pouch, or pocket, with a partially enclosed interior cavity. Bio-indicator insert 13 could then be properly positioned within the interior cavity through the open side of the pouch. With insert 13 properly positioned within the interior cavity, the open side of the pouch could then be welded closed to create the uniform, continuous heat seal 25 about the periphery of FQI 11.

An Ink layer 27 is preferably deposited onto top surface 17-1 of print receptive cover 17 to provide user-intuitive means for utilizing FQI 11. Preferably, a soy-based ink (i.e., that is organic and non-toxic) is utilized for ink layer 27 for safety purposes. As seen most clearly in FIG. 1, ink layer 27 preferably includes a white background region 27-1 that covers the majority of top surface 17-1. However, it is to be understood that the region directly above the indicator region of biosensor solution 21 is not covered by ink layer 27 and, as such, creates a window 27-2 through which solution 21 can be externally observed.

As seen most clearly in FIG. 1, ink layer 27 also preferably includes first and second uniquely colored reference markings 27-3 and 27-4 that are located, in a side-by-side relationship, directly beneath window 27-2. First reference marking 27-3 is preferably printed in a color that represents a low/safe bacterial count for solution 21 (e.g., pink or peach) and second reference marking 27-4 is preferably printed in a color that represents a high/unsafe bacterial count for solution 21 (e.g., violet or dark blue). In this capacity, markings 27-3 and 27-4 serve as reference colors for determining the real-time level of spoilage indicated by biosensor solution 21. To facilitate comprehension of the results in view of reference markings 27-3 and 27-4, ink layer 27 may additionally include some basic instructional text (represented herein as “FRESH” and “NOT Fresh”).

It should be noted that FQI 11 is not limited to a pair of reference markings 27-3 and 27-4 to assist the user in determining the level of food spoilage measured by biosensor solution 21. Rather, alternative style markings, such as a linear scale, could be used in place thereof to provide the user with other means for determining the measured level of food spoilage based on the color status of biosensor solution 21.

Accordingly, it is to be understood that FQI 11 is designed as a single-use product which can be utilized in the following manner to monitor food product spoilage. Specifically, an individual FQI 11 is separated from the remainder of a larger supply that is preferably stored in a refrigerated environment. To activate FQI 11, seal 23 is removed from porous base 15. FQI 11 is then disposed in the immediate vicinity of the food product (e.g., by disposing FQI 11 into a common package with the food product). Over time, FQI 11 senses the presence of amines produced by the food product during decomposition and changes color accordingly. At any point in time, the user can assess the quality of the food product by comparing the color status of biosensor solution 21 (through window 27-2) with reference markings 27-3 and 27-4. If the color of solution 21 more closely matches the color of first reference marking 27-3, the food product is considered safe to consume. However, if the color of solution 21 more closely matches the color of second reference marking 27-4, the food product is considered unsafe to consume and is preferably discarded (along with used FQI 11).

Due to its unitary, water-proof and organic construction, FQI 11 can be safely integrated into a wide variety of potential products, thereby expanding its range of potential applications.

For example, as referenced briefly above, FQI 11 could be used as a self-contained packet that is inserted into the packaging for a particular food product. Specifically, FQI 11 is first activated by removing seal 23. Once activated, FQI 11 is inserted into the packaging for the food package, with the packaging being preferably constructed of a transparent material to allow for visual monitoring of biosensor solution 21. Although not shown herein, a layer of patterned adhesive could be applied to bottom surface 15-2 of base 15, which is exposed when seal 23 is removed, thereby enabling FQI 11 to be similarly affixed to the outer surface of a gas permeable food package.

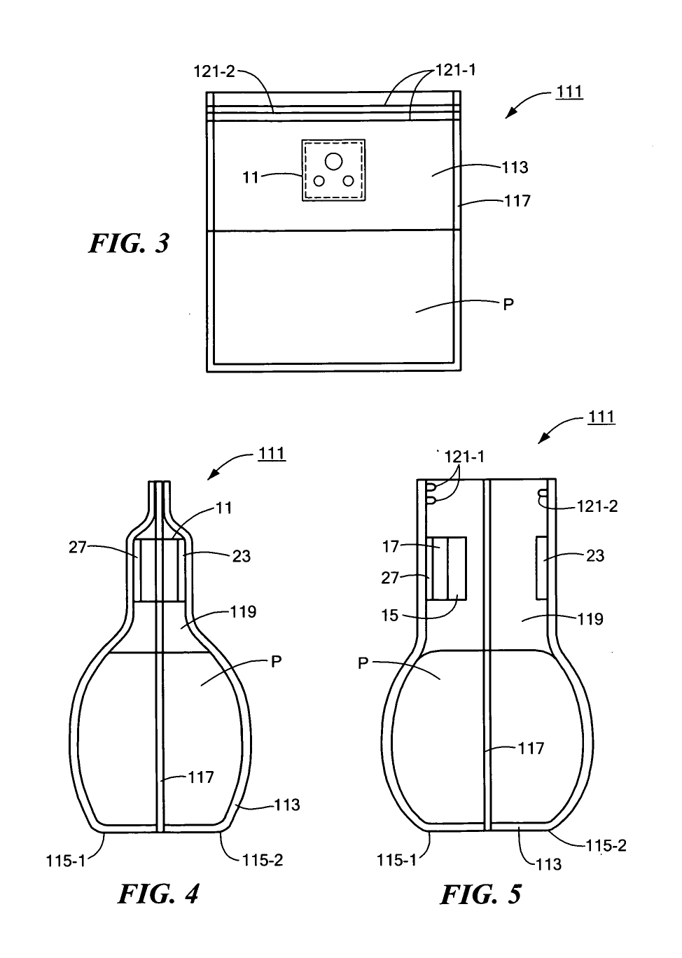

As another example, referring now to FIGS. 3-5, there is shown a container for storing a food product, the container being constructed according to the teachings of the present invention and identified generally by reference numeral 111. As can be seen, food storage container 111 comprises a resealable bag 113 into which is permanently integrated FQI 11.

Sealable bag 113 represents any enclosable bag for retaining food products. In the present example, bag 113 comprises first and second transparent plastic panels 115-1 and 115-2 that are identical in dimension. Panels 115-1 and 115-2 are arranged front-to-back and are permanently welded together along their bottom and side edges by a continuous weld line 117 so as to define a partially enclosed interior cavity 119 for receiving a food product P. Complementary fasteners 121-1 and 121-2 are provided along the top edge of panels 115-1 and 115-2, respectively, which enables bag 113 to be releasably enclosed.

FQI 11 is disposed within interior cavity 119 between food product P and the resealable open top end. In addition, FQI 11 is permanently affixed to panels 115. For example, the exposed surfaces of ink layer 27 and top surface 17-1 are permanently affixed to the inner surface of front panel 115-1 by a patterned adhesive or other similar bonding agent and the exposed surface of seal 23 is similarly permanently affixed to the inner surface of rear panel 115-2 by a patterned adhesive or other similar bonding agent. For reasons to become apparent below, the bonding strength of the adhesive used to affix ink layer 27 and/or top surface 17-1 to front panel 115-1 as well as to affix seal 23 to rear panel 115-2 is substantially greater than the bonding strength of the adhesive used to affix removable seal 23 onto base 15.

With complementary fasteners 121 joined together, as shown in FIG. 4, air is preferably removed from interior cavity 119 so as to create a vacuum seal of food product P within bag 113. Disposed as such, FQI 11 remains in its deactivated state.

When fasteners 121 are separated and bag 113 is suitably opened to access food product P, the vacuum seal around product P is released. At the same time, the force required to open bag 113 to access food product P causes seal 23 to separate from gas permeable base 15, as shown in FIG. 5. As noted briefly above, because the bonding strength of the adhesive used to affix ink layer 27 and/or top surface 17-1 to front panel 115-1 as well as to affix seal 23 to rear panel 115-2 is substantially greater than the bonding strength of the adhesive used to affix removable seal 23 onto base 15, it is to be understood that, when bag 113 is opened, insert 13, base 15 and cover 17 to remain intact and affixed to front panel 115-1 while seal 23 remains affixed to rear panel 115-2.

With seal 23 separated from gas permeable base 15, FQI 11 is activated. Accordingly, it is to be understood that any food product P that remains within interior cavity 119 of resealable bag 113 is monitored for spoilage by activated FQI 11. In this manner, FQI 11 enables the user to easily and accurately determine the precise moment when a previously vacuum sealed food product P becomes spoiled and therefore unsafe for consumption, which is a principal object of the present invention.

It is also to be understood that numerous modifications could be made to FQI 11 to allow for its use in even further potential applications. For instance, it is to be understood that in place of colormetric biometric insert 13, food quality sensor 11 could be provided with an electronic sensor for measuring actual bio-indicator readings (e.g., actual numerical bacterial CFU/g readings). The electronic sensor could be in the form of any electronic sensor that is well-known in the art (e.g., an electronic sensor of the type described in U.S. Patent Application Publication No. 2006/0078658 to M. Owens et al., the disclosure of which is incorporated by reference).

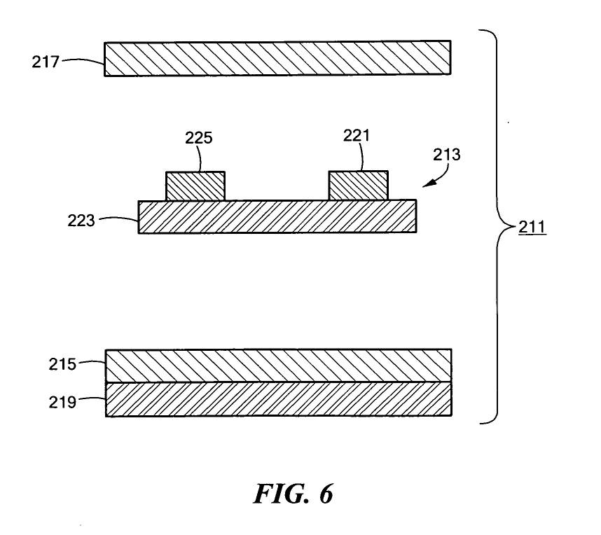

Accordingly, referring now to FIG. 6, there is shown a transverse section view of an electronic food quality indicator, or eFQI, which is constructed according to the teachings of the present invention and identified generally as eFQI 211. As can be seen, eFQI 211 comprises an electronic sensor insert 213 that is interposed and sealed between a gas permeable base 215 and an impervious cover 217. Similar to FQI 11, eFQI 211 includes a removable seal 219 affixed to the exposed underside of gas permeable base 215 to prevent inadvertent contamination of insert 213 prior to activation.

Insert 213 includes an electronic sensor 221 that is disposed on a substrate 223. In addition, a microprocessor 225 is similarly mounted on substrate 223 in electrical connection with sensor 221. In this capacity, microprocessor 225 functions, inter alia, to store electronic data captured by electronic sensor 221. Microprocessor 225 is in turn provided with uniquely identifiable signal transmission means (e.g., using known radio frequency identification (RFID) technology) to wirelessly transmit, at specified intervals, food quality data to a central station for analysis, as will be described further below. In this manner, eFQI 211 could be used to monitor, among other things, bulk quantities of meat located within a shipping container, pallet, vehicle and/or storage facility.

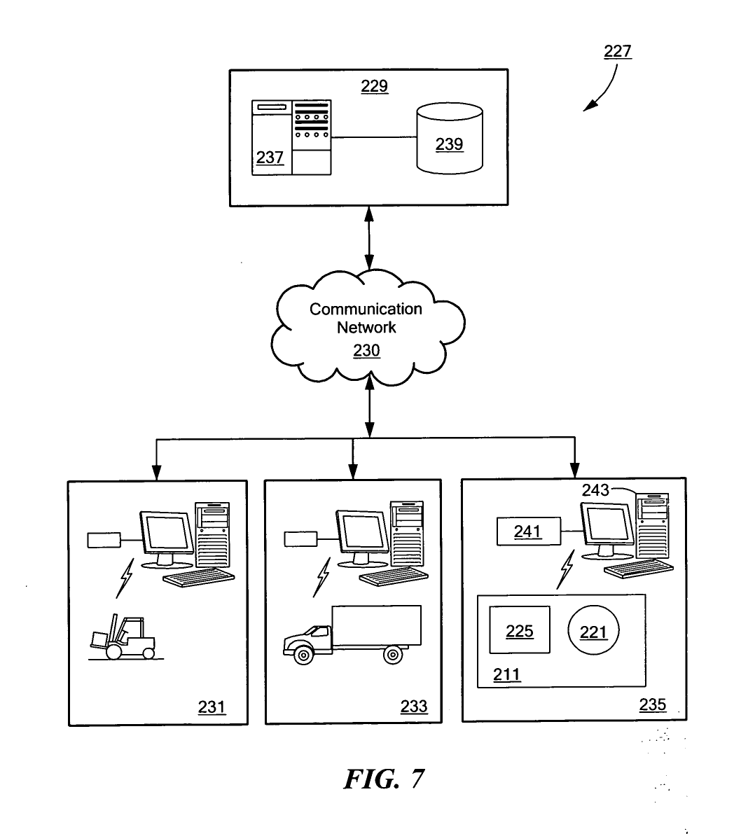

Specifically, referring now to FIG. 7, there is shown a simplified block diagram of a food supply chain management system constructed according to the teachings of the present invention and identified generally by reference numeral 227. As will be described further below, system 227 allows for greater monitoring and control of food products at all stages of the food supply chain.

As can be seen, system 227 comprises a centralized hub 229 that is electronically linked with various participants in the food supply chain via a communication network 230, such as the internet. For purposes of simplicity only, hub 229 is shown herein as being linked with a supplier 231, a distributor 233 and a retailer 235. However, it is to be understood that fewer and/or additional participants of the supply chain could be included in system 227 without departing from the spirit of the present invention.

Hub 229 includes a compute device 237, such as a server, and a food contaminants database 239 that stores food quality information received from the various supply chain participants, as will be described further in detail below.

In the present example, eFQI 211 is shown in use by retailer 235 (e.g., affixed to gas permeable food packaging for a food product displayed on the customer floor). eFQI 211 is designed to measure amine levels and, in turn, wirelessly transmit the measured data to a local reader 241 that is, in turn, linked with a local compute device 243.

A software module is preferably provided on either local compute device 243 and/or server 237 that is designed to receive bio-indicator readings from each uniquely identified eFQI 211, the software module being aligned with standard supply chain and logistics tracking needs.

As can be appreciated, the software module is preferably designed to allow for at least some of the following advantages in food supply chain management.

As a first advantage, the software module is preferably designed with a proactive alarm to protect the general public from consuming unsafe products by continuously monitoring the bacterial readings of foods at various stages of the supply chain and with various packaging levels (e.g., individual, pallet, crate, etc.). In this sense, the software will function in a similar capacity to temperature monitoring software but rather than monitoring the surrounding environment of the product, the software will analyze bacterial data associated with the product.

As a second advantage, the software module can be used to capture and analyze bacterial counts as products are transferred from one part of the supply chain to another. As a result, the quality of products can be managed before accepting a shipment (i.e., written into contracts or even into cargo insurance policies).

As a third advantage, the software module can be integrated into existing supply chain software, thereby enabling transmitted bio-indicator data to be compatible with third party software.

As noted above, food contaminants database 239 is designed to store food quality information received from the various supply chain participants. As a result, the data accumulated by database 239 can be used to improve the management of products at various stages of the supply chain. For example, as database 239 accumulates data relating to various types of bacteria, foods and environments, a profile is created that can be used to facilitate management of the supply chain. More specifically, a profile relating to the decomposition of 95% lean ground beef supplied from a particular farm in a certain location can be created that provides basic spoilage information (e.g., results indicate that the supplied beef is likely to spoil within 30 days of its initial packaging date).

The embodiments shown in the present invention are intended to be merely exemplary and those skilled in the art shall be able to make numerous variations and modifications to them without departing from the spirit of the present invention. All such variations and modifications are intended to be within the scope of the present invention as defined in the appended claims.

What is claimed is:

1. A food quality indicator comprising:
(a) a gas-permeable and waterproof base, the base having a top surface and a bottom surface;
(b) an impervious transparent cover, the cover having a top surface and a bottom surface; and
(c) a bio-indicator insert interposed between the base and the cover, the bio-indicator insert being adapted to sense the presence of compounds characteristic of decomposing food, at least a portion of the bio-indicator insert being externally viewable through the transparent cover;
(d) wherein the base and transparent cover are coupled together so as to completely enclose the bio-indicator insert therebetween.

2. The food quality indicator as claimed in claim 1 wherein the top surface of the base and the bottom surface of the transparent cover are sealed together about their peripheries so as to completely enclose the bio-indicator insert therebetween.

3. The food quality indicator as claimed in claim 2 wherein the bio-indicator insert is adapted to change color in response to sensing compounds characteristic of decomposing food.

4. The food quality indicator as claimed 3 wherein the bio-indicator insert is adapted to change color within a defined color range that is dependent upon the concentration of amines detected.

5. The food quality indicator as claimed in claim 1 wherein the bio-indicator insert comprises:
(a) a porous substrate; and
(b) a biosensor solution applied to the porous substrate, the biosensor solution having an active ingredient that is adapted to change color within a defined color range that is dependent upon the concentration of amines detected.

6. The food quality indicator as claimed in claim 5 wherein the active ingredient of the biosensor solution is selected from the group consisting of cabbage extract, beet extract, anthocyanins, anthocyanidins, flavonoids, belatin, belatin derivates and combinations thereof.

7. The food quality indicator as claimed in claim 5 wherein the porous substrate is in the form of pH neutral, contaminant-free, cellulose paper.

8. The food quality indicator as claimed in claim 1 further comprising an impervious seal that is removably coupled to the bottom surface of the base.

9. The food quality indicator as claimed in claim 8 wherein the seal is dimensioned to cover the entire bottom surface of the base.

10. The food quality indicator as claimed in claim 4 wherein the top surface of the cover is print receptive.

11. The food quality indicator as claimed in claim 10 further comprising an ink layer applied to the top surface of the cover.

12. The food quality indicator as claimed in claim 11 wherein the ink layer is constructed using an organic, non-toxic material.

13. The food quality indicator as claimed in claim 12 wherein the ink layer includes first and second uniquely colored reference markings that fall within the defined color range.

14. A container for a food product, comprising:
(a) a bag shaped to define an interior cavity that is accessible through an opening; and
(b) a food quality indicator disposed within the interior cavity of the bag, the food quality indicator comprising,
(i) a gas-permeable and waterproof base, the base having a top surface and a bottom surface,
(ii) an impervious transparent cover, the cover having a top surface and a bottom surface, and
(iii) a bio-indicator insert interposed between the base and the cover, the bio-indicator insert being adapted to sense the presence of compounds characteristic of decomposing food, at least a portion of the bio-indicator insert being externally viewable through the transparent cover,
(iv) wherein the base and transparent cover are coupled together so as to completely enclose the bio-indicator insert therebetween.

15. The container as claimed in claim 14 wherein the top surface of the base and the bottom surface of the transparent cover are sealed together about their peripheries so as to completely enclose the bio-indicator insert therebetween.

16. The container as claimed in claim 15 wherein the bio-indicator insert is adapted to change color within a defined color range that is dependent upon the concentration of amines detected.

17. The container as claimed in claim 15 wherein the food quality indicator further comprises an impervious seal that is removably bonded to the bottom surface of the base.

18. The container as claimed in claim 17 wherein the food quality indicator is bonded to the bag.

19. The container as claimed in claim 18 wherein the impervious seal is bonded to the bag.

20. The container as claimed in claim 19 wherein the bonding strength of the impervious seal to the bag is greater than the bonding strength of the impervious seal to the base.
